(19) United States
(12) Patent Application Publication
(10) Pub. No.: US 2014/0173466 A1
(43) Pub. Date: Jun. 19, 2014

(54) TRANSITIONS WITHIN VIEWS OF CONVERSATION ENVIRONMENTS

(71) Applicant: MICROSOFT CORPORATION, Redmond, WA (US)

(72) Inventors: Manpratap Suri, Redmond, WA (US); Christina M. Meyer, Seattle, WA (US); Joshua Hinds, Duvall, WA (US); Nathan Arthur Gunderson, Snoqualmie, WA (US); Punit Java, Seattle, WA (US); Kris Richard Durgin, Seattle, WA (US); Dengkui Xi, Redmond, WA (US); Zaoyang Gong, Redmond, WA (US); Phillip Dean Garding, North Bend, WA (US); Xiaoyu Li, Issaquah, WA (US); Tatiana Racheva, Seattle, WA (US)

(73) Assignee: Microsoft Corporation, Redmond, WA (US)

(21) Appl. No.: 13/715,089

(22) Filed: Dec. 14, 2012

(51) Int. Cl. G06F 3/048

(52) U.S. Cl. CPC G06F 3/048
USPC 715/758

(57) ABSTRACT

Disclosed herein are systems, methods, and software for facilitating conversation environments. In an implementation, a view of a conversation environment is presented that includes a conversation component within which to present communications exchanged during a conversation between a participants in the conversation. In response to a participant list gesture, the view is modified to include a list component presented over a portion of the conversation component. The list component may include contacts associated with the participants in the conversation. In response to a contact gesture corresponding to one of the contacts, the view is modified again to replace the list component with a contact component associated with the one of the contacts. In some implementations the view is a single window view within which the components are arranged.

### TECHNICAL FIELD

Aspects of the disclosure are related to computing and communication technology, and in particular, to conversation applications and environments.

### TECHNICAL BACKGROUND

Conversation applications allow participants in a conversation to exchange communications with each other. The conversation may be carried out by phone, video conference, instant messaging or by some other form of communication exchange between the participants. Conversation applications may at times be implemented as stand-alone applications but may also be integrated within other applications. A variety of communication devices and other computing systems support conversation applications, such as laptop, desktop, and tablet computers, smart phones, and gaming devices.

Many conversation applications when executed provide for the rendering of conversation environments with which the participants in a conversation may interact to carry out various functions related to the conversation or other aspects of the application. Some conversation environments may be presented within multi-window contexts that allow for the presentation of multiple windows that persist independently of each other.

For example, a conversation environment may include a main conversation window within which communications are exchanged. The conversation environment may also include a separate window within which contacts associated with the participants in the conversation may be viewed. The selection of one of the contacts may trigger the presentation of yet another, independently persistent window containing contact information for the selected contact. In some cases, the multiple windows may be nested such that a user cannot navigate back to a root window without first closing any intermediate windows.

### Overview

Provided herein are systems, methods, and software for facilitating conversation environments. In an implementation, a view of a conversation environment is presented that includes a conversation component within which to present communications exchanged during a conversation between a participants in the conversation. In response to a participant list gesture, the view is modified to include a list component presented over a portion of the conversation component. The list component may include contacts associated with the participants in the conversation. In response to a contact gesture corresponding to one of the contacts, the view is modified again to replace the list component with a contact component associated with the one of the contacts. In some implementations the view is a single window view within which the components are arranged.

This Overview is provided to introduce a selection of concepts in a simplified form that are further described below in the Technical Disclosure. It should be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a transition process involving a view of a conversation environment in an implementation.

FIG. 2 illustrates various transitions within a view of a conversation environment in an implementation.

FIG. 3 illustrates a computing system suitable for implementing transition process and a conversation environment.

FIG. 4 illustrates various transitions within a view of a conversation environment in an implementation.

FIG. 5 illustrates various transitions within a view of a conversation environment in an implementation.

FIG. 6 illustrates various transitions within a view of a conversation environment in an implementation.

FIG. 7 illustrates various transitions within a view of a conversation environment in an implementation.

FIG. 8 illustrates various transitions within a view of a conversation environment in an implementation.

FIG. 9 illustrates various transitions within a view of a conversation environment in an implementation.

### TECHNICAL DISCLOSURE

Implementations described herein provide for enhanced transitions within views of conversation environments. The enhanced transitions provide users with unobtrusive ways to navigate within and interact with conversation environments by replacing or subsuming various components within a conversation environment with other components. In at least one implementation, a view of a conversation environment is modified to present a list component over a portion of a conversation component responsive to a participant list gesture. Then, responsive to a contact gesture, the list component is replaced with a contact component. A user may return to the list component by way of a back gesture, but may also proceed to another contact component. To return to the list component from the additional contact component, the user need only indicate that intention by way of another back gesture, rather than navigate through the previously presented contact component.

Some operational scenarios may involve the presentation of a conversation environment within a single window view and the application of the enhanced transitions therein, although the enhanced transitions may be applicable to multiple window environments as well. In such scenarios involving single window views, the various components rendered within the single window view may be presented in such a way that the user experiences no more than two layers. For example, at a first layer a conversation canvas may be presented within which conversation communications are embedded. A list gesture, such as a swipe or slide from the left, top, bottom, or right of the conversation canvas, may trigger the rendering of a list panel that is presented one layer above or over the conversation canvas.

A selection of a contact presented within the list panel may result in the rendering of a contact panel at the same layer or on the same plane as the list panel. In fact, the list panel may be replaced or subsumed entirely by the contact panel. The contact panel itself may also include other contacts, the selection of which may trigger the rendering of an additional contact panel, again at the same layer or on the same plane as both the initial contact panel and the list panel. In fact, the initial contact panel may be replaced by the additional contact panel, just as the initial contact panel replaced the list panel.

In some implementation scenarios, the various contact panels may be linked or chained directly to the list panel such that returning to the list panel from a contact panel can be achieved in a single gesture. From the preceding example above, a user may return to the list panel by selecting a back button included within the contact panel or making some other suitable back gesture. Even when viewing the additional contact panel which was navigated to from within the initial contact panel, the selection of a back button or making some other suitable back gesture may return the user directly to the list panel, rather than requiring the user to navigate back through the initial contact panel or any other intermediate panels. In fact, some technical aspects may be appreciated from the forthcoming examples, such as improved processing power, battery life, and other resource utilization due to the unobtrusive way in which conversation environments may be presented within single window implementations.

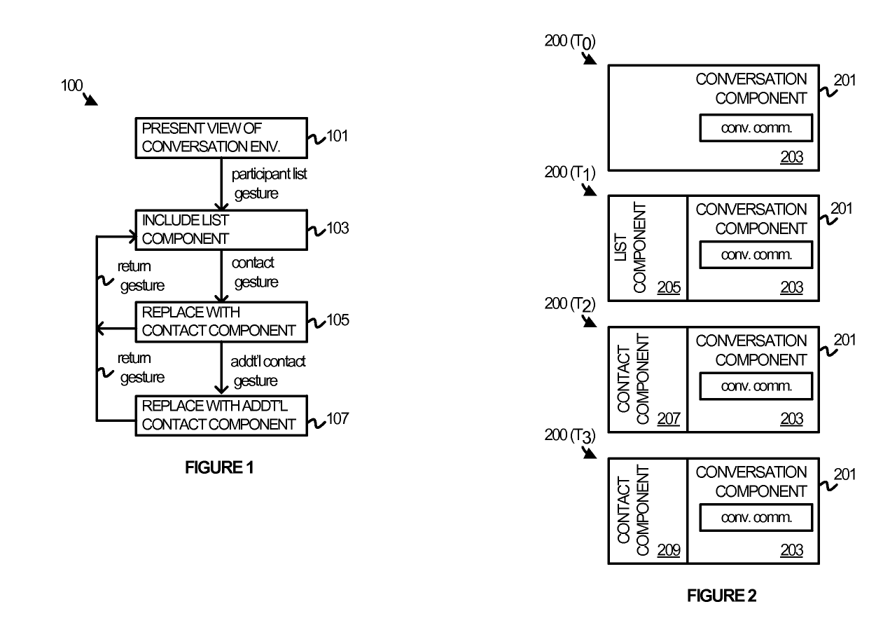

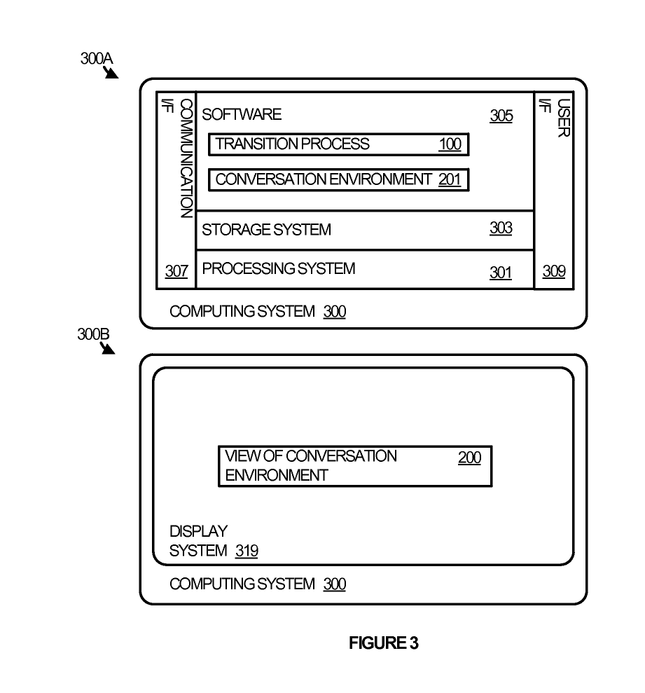

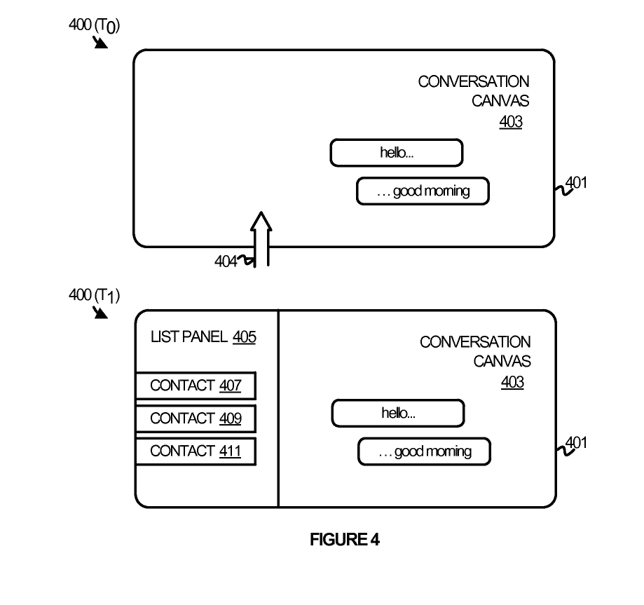

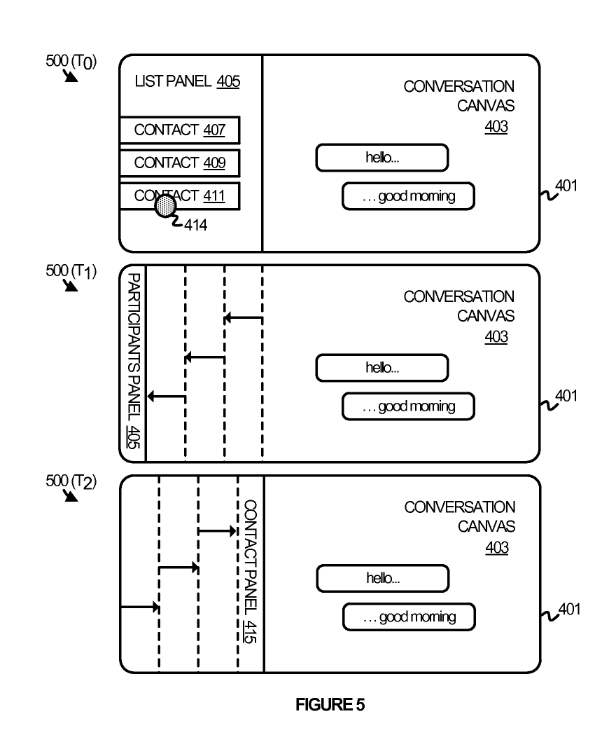

Referring now to the drawings, FIG. 1 illustrates a transition process 100 that describes various transitions that may occur within a view of a conversation environment in response to various gestures provided by a user. FIG. 2 illustrates an exemplary view of one conversation environment and some exemplary transitions through the view. FIG. 3 illustrates a computing system suitable for implementing the transition process and conversation environment described in FIG. 1 and FIG. 2 respectively. FIGS. 4-9 illustrate several more views of a conversation environment and transitions therein.

Referring now to FIG. 1, transition process 100 is illustrated for transitioning a view of a conversation environment in an implementation. Transition process 100 may be implemented, for example, in the context of executing a conversation application. Initially, a view of a conversation environment is presented (step 101). The view may include a conversation component within which communications exchanged during a conversation between participants in the conversation may be presented. As an example, text exchanged via instant messages between the participants may be displayed within the conversation component.

The view of the conversation environment may be modified in various ways in response to various user inputs or interactions during the course of a conversation or other operations. For example, a user may interact with the conversation environment by way of gestures to control the view of the conversation environment. In response to one such gesture, sometimes referred to as a participant list gesture, the conversation environment is modified to include a list component presented over a portion of the conversation component (step 103). The list component is a component that includes, possibly among other things, contacts associated with the participants in a conversation.

The user may continue to control or otherwise interact with the contact environment by way of gestures associated with the contacts or other elements included in the list component. With respect to the contacts, the user may desire to view contact information associated with one of the contacts as indicated by another gesture, sometimes referred to as a contact gesture. In response to the contact gesture, the list component is replaced with a contact component associated with the selected contact (step 105). The contact component may include, for example, contact information associated with the contact, such as a name, an email address, a phone number, or a photo, as well as other types of contact information, combinations of contact information, or variations thereof.

The contact component may also include additional contacts. The additional contacts may be those associated with the contact represented by the contact component. Thus, the user may again select a contact by way of an additional contact gesture, this time from the contact component rather than the list component. In response to the additional contact gesture, the contact component is replaced with an additional contact component (step 107). The additional contact component may also include, for example, contact information associated with the additional contact, such as a name, an email address, or phone number, or a photo, as well as other types of contact information, combinations of contact information, or variations thereof.

When presented with either the contact component or the additional contact component, the user may be able to return directly to the list component by way of a return gesture, a back gesture, or some other type of user input indicative of an intention to return the list component. The contact component and the additional contact component may each include, for example, a back graphic that when touched or otherwise selected initiates a return to the list component. In this manner, a direct link may be preserved from any contact component to the list component, even if the contact component was reached by way of several navigation steps through another or other contact components. It may also be appreciated that other gestures or types of interactions with the contact component or additional contact component are possible. For example, the additional contact component may also include other contacts that may also be selected, resulting in the replacement of the additional contact component with another additional contact component.

Variations of transition process 100 are possible, such as initiating each of the aforementioned steps, in addition to or in place of actually performing each of the aforementioned steps. For example, transition process 100 may include initiating the presentation of a conversation environment and initiating modifications to the conversation environment, among other steps that may be initiated. In addition, others steps in addition to or in place of those described by transition process 100 may be implemented.

FIG. 2 illustrates several transitions with respect to a view 200 of a conversation environment 201 in an implementation that may occur when executing transition process 100. Initially, view 200 of conversation environment 201 includes conversation component 201 (t0). Conversation component 203 may include text or other representations of communications exchanged during a conversation between participants in a conversation. As an example, text exchanged via instant messages between the participants may be displayed within the conversation component.

In operation, a user may interact with conversation environment 201 by way of gestures. In response to a participant list gesture, for example, view 200 of conversation environment 201 transitions to a state that includes list component 205 presented over a portion of conversation component 203 (t1). List component 205 may include contacts representative of the participants in the conversation. List component 205 may be, for example, a panel, a card, a separate window, or some other type of component suitable for presenting contacts representative of the participants in the conversation. While in view 200 list component 205 is represented as arranged towards the left portion of conversation component 203, it may be appreciated that list component 205 could be arranged otherwise, such as positioned towards the top, bottom, middle, or right portion of conversation component 203.

In response to a contact gesture indicative of an intention to view one of the contacts included in list component 205, list component 205 is replaced with contact component 207 (t2). Contact component 207 may include, for example, contact information associated with the contact, such as a name, an email address, a phone number, or a photo, as well as other types of contact information, combinations of contact information, or variations thereof. Contact component 207 may be, for example, a panel, a card, a separate window, or some other type of component suitable for presenting contact information associated with a contact. While in view 200 contact component 207 is represented as arranged towards the left portion of conversation component 203, it may be appreciated that contact component 207 could be arranged otherwise, such as positioned towards the top, bottom, middle, or right portion of conversation component 203.

Contact component 207 may also include additional contacts. The additional contacts may be those associated with the contact represented by the contact component. Thus, the user may again select a contact by way of an additional contact gesture. In response to the additional contact gesture, contact component 207 is replaced with additional contact component 209 (t4). Additional contact component 209 may also include, for example, contact information associated with the additional contact, such as a name, an email address, or phone number, or a photo, as well as other types of contact information, combinations of contact information, or variations thereof. Additional contact component 209 may be, for example, a panel, a card, a separate window, or some other type of component suitable for presenting contact information associated with a contact. While in view 200 additional contact component 209 is represented as arranged towards the left portion of conversation component 203, it may be appreciated that additional contact component 209 could be arranged otherwise, such as positioned towards the top, bottom, middle, or right portion of conversation component 203.

When presented with either the contact component or the additional contact component, the user may be able to return directly to the list component by way of a return gesture, a back gesture, or some other type of user input indicative of an intention to return the list component. The contact component and the additional contact component may each include, for example, a back graphic that when touched or otherwise selected initiates a return to the list component. In this manner, a direct link may be preserved from any contact component to the list component, even if the contact component was reached by way of several navigation steps through another or other contact components. It may also be appreciated that other gestures or types of interactions with the contact component or additional contact component are possible. For example, the additional contact component may also include other contacts that may also be selected, resulting in the replacement of the additional contact component with another additional contact component.

FIG. 3 illustrates an internal view 300A and an external view 300B of computing system 300, which may be representative of any computing apparatus, system, or systems on which transition process 100 or variations thereof may be suitably implemented. Optionally, computing system 300 may also be suitable for implementing all of or portions of conversation environment 201. Implementing transition process 100 or variations thereof may include local execution, streaming execution, or hosted execution of transition process 100, or any combination or variation thereof. Examples of computing system 300 include mobile computing devices, desktop computers, cell phones, tablet computers, laptop computers, notebook computers, media devices, and gaming devices, as well as any other type of mobile computing devices and any combination or variation thereof. Examples of computing system 300 may also include server computers, cloud computing platforms, and virtual machines, as well as any variation or combination thereof.

Computing system 300 includes processing system 301, storage system 303, software 305, communication interface 307, and user interface 309. Processing system 301 is operatively coupled with storage system 303, communication interface 307, and user interface 309. Processing system 301 loads and executes software 305 from storage system 303. When executed by computing system 300 in general, and processing system 301 in particular, software 305 directs computing system 300 to operate as described herein for transition process 100 or variations thereof. Computing system 300 may optionally include additional devices, features, or functionality not discussed here for purposes of brevity.

Referring still to FIG. 3, processing system 301 may comprise a microprocessor and other circuitry that retrieves and executes software 305 from storage system 303. Processing system 301 may be implemented within a single processing device but may also be distributed across multiple processing devices or sub-systems that cooperate in executing program instructions. Examples of processing system 301 include general purpose central processing units, application specific processors, and logic devices, as well as any other type of processing device, combinations, or variations thereof.

Storage system 303 may comprise any computer readable storage media readable by processing system 301 and capable of storing software 305. Storage system 303 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the storage media a propagated signal. In addition to storage media, in some implementations storage system 303 may also include communication media over which software 305 may be communicated internally or externally. Storage system 303 may be implemented as a single storage device but may also be implemented across multiple storage devices or sub-systems co-located or distributed relative to each other. Storage system 303 may comprise additional elements, such as a controller, capable of communicating with processing system 301.

Software 305 may be implemented in program instructions and among other functions may, when executed by computing system 300 in general or processing system 301 in particular, direct computing system 300 or processing system 301 to operate as described herein for transition process 100. Software 305 may include additional processes, programs, or components, such as operating system software or other application software. Software 305 may also comprise firmware or some other form of machine-readable processing instructions executable by processing system 301.

In general, software 305 may, when loaded into processing system 301 and executed, transform computing system 300 overall from a general-purpose computing system into a special-purpose computing system customized to facilitate conversation environments as described herein for each implementation. Indeed, encoding software 305 on storage system 303 may transform the physical structure of storage system 303. The specific transformation of the physical structure may depend on various factors in different implementations of this description. Examples of such factors may include, but are not limited to the technology used to implement the storage media of storage system 303 and whether the computer-storage media are characterized as primary or secondary storage.

For example, if the computer-storage media are implemented as semiconductor-based memory, software 305 may transform the physical state of the semiconductor memory when the program is encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate this discussion.

It should be understood that computing system 300 is generally intended to represent a computing system with which software 305 is deployed and executed in order to implement transition process 100 (and variations thereof) and optionally all or portions of conversation environment 201. However, computing system 300 may also represent any computing system on which software 305 may be staged and from where software 305 may be distributed, transported, downloaded, or otherwise provided to yet another computing system for deployment and execution, or yet additional distribution.

Referring again to FIG. 1 and FIG. 2, through the operation of computing system 300 employing software 305, transformations may be performed with respect to conversation environment 201. As an example, conversation environment 201 could be considered transformed from one state to another when subject to transition process 100 or variations thereof. In a first state, computing system 300 may render the view 200 of conversation environment 201 include list component 205. Responsive to a contact gesture, the view 200 of conversation environment 201 may transition to include contact component 207 in replacement of list component 205, thereby changing conversation environment 201 to another, different state.

Referring again to FIG. 3, communication interface 307 may include communication connections and devices that allow for communication between computing system 300 and other computing systems (not shown) over a communication network or collection of networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

User interface 309 may include a mouse, a voice input device, a touch input device for receiving a touch gesture from a user, a motion input device for detecting non-touch gestures and other motions by a user, and other comparable input devices and associated processing elements capable of receiving user input, such as inclusion gestures and option gestures, from a user. Output devices such as a display, speakers, haptic devices, and other types of output devices may also be included in user interface 309. In some cases, the input and output devices may be combined in a single device, such as a display or surface capable of displaying images, such as views of conversation environment 201, and receiving touch gestures. The aforementioned user input and output devices are well known in the art and need not be discussed at length here. User interface 309 may also include associated user interface software executable by processing system 301 in support of the various user input and output devices discussed above. Separately or in conjunction with each other and other hardware and software elements, the user interface software and devices may provide a graphical user interface, a natural user interface, or any other kind of user interface.

As an example, computing system 300 includes display system 319, representative of a portion of user interface 309. Display system 319 is capable of displaying or otherwise presenting view 200 of conversation environment 201. In some implementation scenarios display system 319 may be a display with which a user may interact, such as a touch screen other similar surface capable of receiving gestures.

FIGS. 4-9 illustrate several views of a conversation environment that may be presented using a user interface, such as user interface 309 in general and display system 319 in particular. In particular, FIGS. 4-9 illustrate various transitions that may occur as a user interacts with conversation environment 401. Conversation environment 401 and the various views provided in FIGS. 4-9 are representative of views and environments that may be rendered when executing a conversation application, Microsoft® Lync®, or some other application that may provide similar functionality. In addition, conversation environment 401 and the various views provided in FIGS. 4-9 are representative of single window environments and views. In such scenarios,

Referring now to FIG. 4, a scenario is illustrated where view 400 of conversation environment 401 transitions to include a list component in response to a gesture. In particular, view 400 of conversation environment 401 is initially presented with conversation canvas 403 included thereon (t0). Conversation canvas 403 is a canvas on which conversation communications may be displayed. In this implementation, conversation canvas visually occupies the entirety of the visual space allocated to conversation environment 401. In addition, conversation canvas 403 persists such that it is always at least partially visible.

At times, other components may be displayed over conversation canvas 403 in response to various gestures or other user input. Gesture 404 is one example whereby a user may make a swiping or sliding gesture moving from the bottom most portion of conversation environment 401 to the right, indicative of an intention to draw out list panel 405. In response to gesture 404, list panel 405 is displayed, including contact 407, contact 409, and contact 411. Contact 407, contact 409, and contact 411 may each represent one of the participants in an ongoing conversation within conversation environment 401.

FIG. 5 illustrates a scenario whereby view 500 of conversation environment 401 transitions from including list panel 405 to a contact panel. In operation, a user may make gesture 414 indicative of an intention to view more details about contact 411 (t0). Gesture 414 may be a touch or some other suitable type of selection. In response to gesture 414, list panel 405 slides out of view (t1). Contact panel 415 replaces list panel 405, which slides into view.

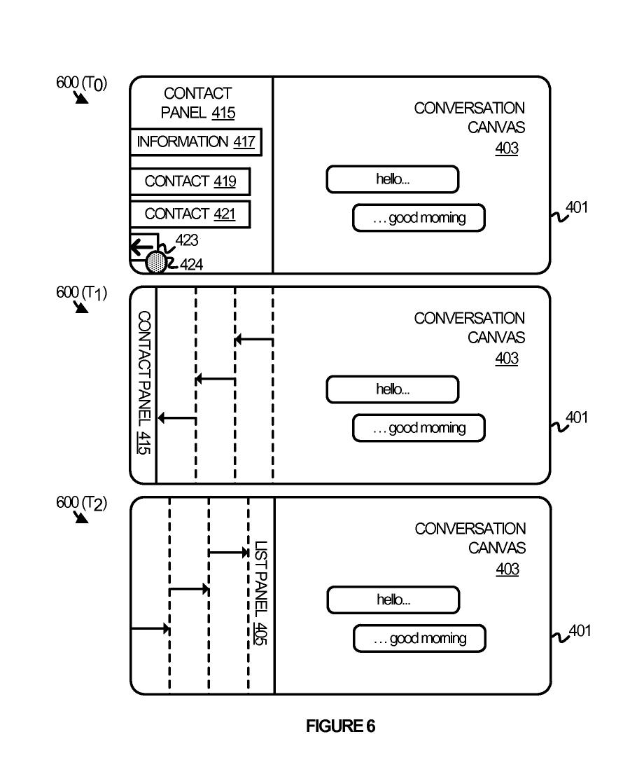

In FIG. 6, contact panel 415 is presented and includes information 417, contact 419, contact 421, and back button 423 (t0). Information 417 may be specific contact information pertaining to the participant associated with contact 411, such as a phone number, an email address, or other similar types of contact information. Contact 419 and contact 421 may be contacts associated with the participant. Back button 423 provides a mechanism by which the user may return to list panel 405.

Indeed, in FIG. 6 the user selects back button 423 by way of gesture 424, thereby indicating an intention to return to list panel 405. Contact panel 415 is responsively dismissed from view 600 of conversation environment 401 (t1), again by way of a rendering of a slide animation (t1). Upon contact panel 415 receding from view, list panel 405 is brought back into view by another rendering of a slide animation (t2). The view of conversation environment 401 is returned to the initial state illustrated in FIG. 5 that includes the contacts corresponding to the participants in the conversation.

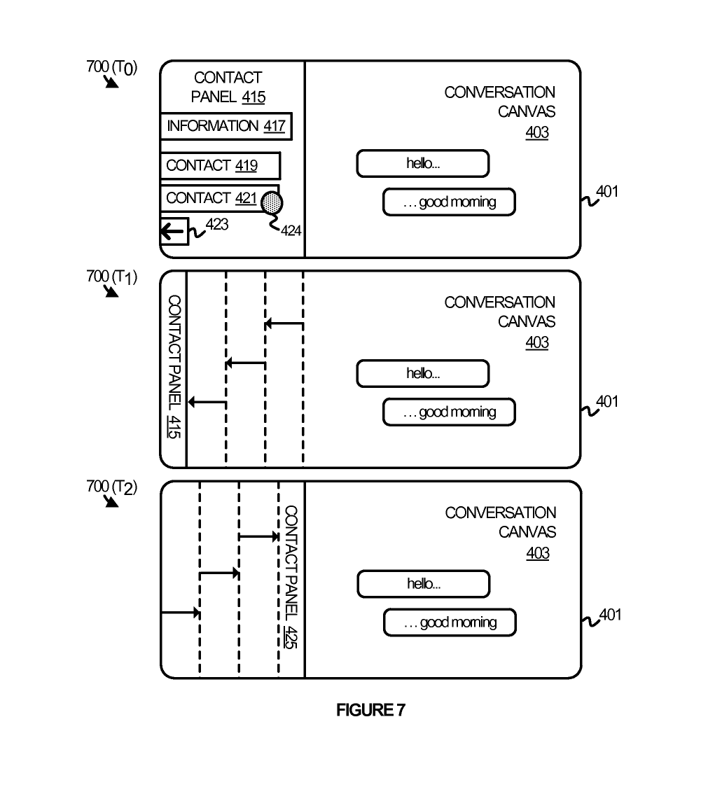

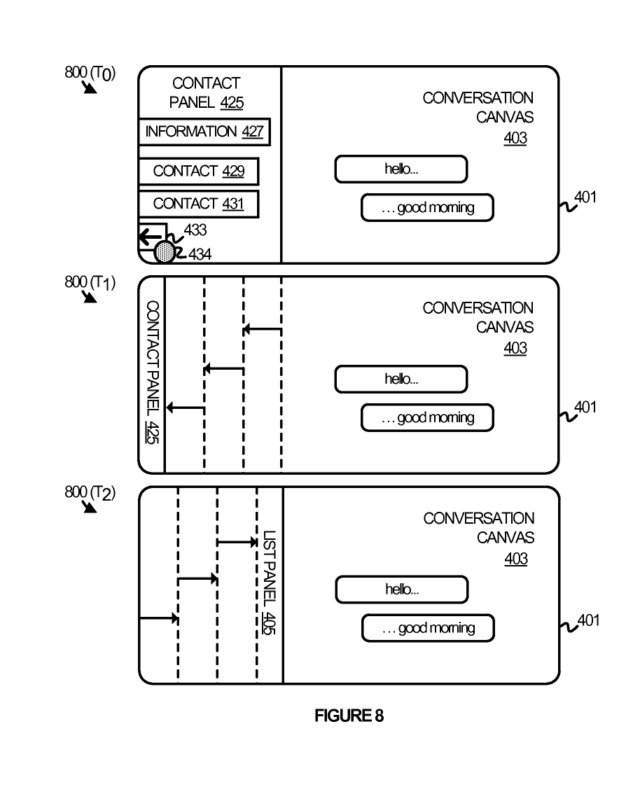

FIG. 7 illustrates a different scenario involving contact panel 415. Initially, contact panel 415 is displayed in the same beginning state as in FIG. 6, with information 417, contact 419, contact 421, and back button 423 included therein. However, in this scenario the user selects contact 421 by way of gesture 424 (t0). The selection of contact triggers contact panel 415 to slide out of view 700 (t1). Upon contact panel 415 sliding out of view, contact panel 425, corresponding to contact 421, slides into view (t2).

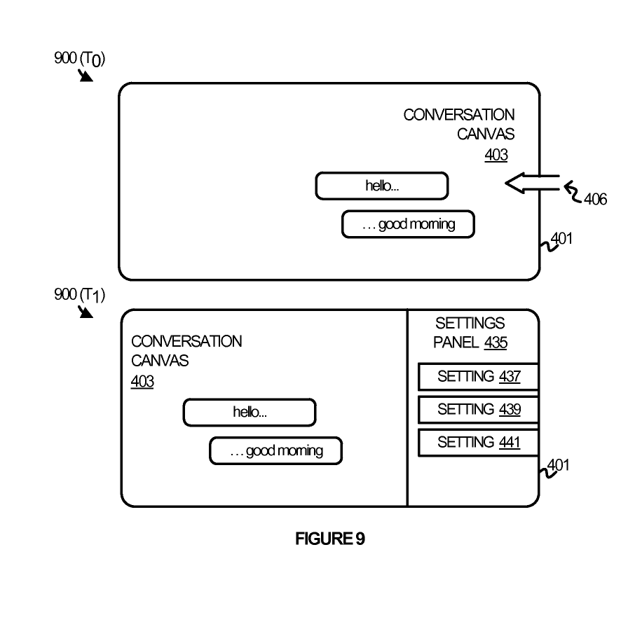

Contact panel 425 illustrated in FIG. 8 is similar to contact panel 415 and includes information 427, contact 429, contact 431, and back button 433 (t0). The scenario illustrated in FIG. 8 illustrates that the selection of back button 433 returns view 800 of conversation environment 401 to list panel 405. Indeed, in response to gesture 434 selecting back button 433, contact panel 425 slides out of view (t1) and list panel 405 slides into view, returning conversation environment 401 to a state similar to the initial state described with respect to FIG. 5.

FIG. 9 illustrates another scenario whereby a user indicates an intention by way of gesture 406 to view a settings panel. In this scenario, view 900 of conversation environment 401 includes conversation canvas 403 with respect to which gesture 406 is received. Gesture 406 may be, for example, a slide or swipe gesture proceeding from the right most portion of conversation environment 401 to the left. In response to gesture 406, settings panel 435 is presented over conversation canvas 403 (t1). Settings panel 435 includes setting 437, setting 439, and setting 441, representative of various settings that may be controlled by the user. For illustrative purposes, the conversation communications displayed on conversation canvas have been shifted to the left, although it may be appreciated that settings panel 435 may be presented such that the conversation communications are also at least partially obstructed from view.

The functional block diagrams, operational sequences, and flow diagrams provided in the Figures are representative of exemplary architectures, environments, and methodologies for performing novel aspects of the disclosure. While, for purposes of simplicity of explanation, methods included herein may be in the form of a functional diagram, operational sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The preceding discussion of FIGS. 1-9 for purposes of clarity may refer to various elements included in various conversation environments, such as components, panels, contacts, additional contacts, and back buttons without reference to those elements as graphical objects or graphical representations of the same. However, it may be appreciated that such terms and phrases may be used interchangeably and such usage does not limit the scope of the present disclosure. To the contrary, the present disclosure may be considered to encompass a wide variety of techniques for representing the various elements included in the various conversation environments discussed throughout. Thus, these and other elements illustrated in FIGS. 1-9 may embodied in graphical objects, other data structures, other graphical representations of the elements, or other combinations or variations thereof.

The included descriptions and figures depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. One or more computer readable storage media having program instructions stored thereon for facilitating transitions within a conversation environment that, when executed by a computing system, direct the computing system to at least:
present a view of the conversation environment comprising a conversation component within which to present communications exchanged during a conversation between a plurality of participants in the conversation;
in response to a participant list gesture, modify the view of the conversation environment to include a list component presented over a portion of the conversation component and comprising a plurality of contacts associated with the plurality of participants in the conversation; and,
in response to a contact gesture corresponding to one of the plurality of contacts, modify the view of the conversation environment to replace the list component with a contact component associated with the one of the plurality of contacts.

2. The one or more computer readable storage media of claim 1 wherein the contact component comprises a plurality of additional contacts associated with the one of the plurality of contacts and wherein the program instructions further direct the computing system to, in response to an additional contact gesture corresponding one of the plurality of additional contacts, modify the view of the conversation environment to replace the contact component with an additional contact component.

3. The one or more computer readable storage media of claim 2 wherein the program instructions further direct the computing system to modify the view of the conversation environment to replace the contact component with the list component in response to a return gesture corresponding to a return component within the contact component.

4. The one or more computer readable storage media of claim 3 wherein the program instructions further direct the computing system to modify the view of the conversation environment to replace the additional contact component with the list component in response to an additional return gesture corresponding to an additional back component within the additional contact component.

5. The one or more computer readable storage media of claim 2 wherein the list component comprises a list panel, wherein the contact component comprises a contact panel, wherein the additional contact component comprises an additional contact panel, and wherein the view of the conversation environment comprises a single window view within which the list panel, the contact panel, and the additional contact panel are arranged.

6. The one or more computer readable storage media of claim 5 wherein, to modify the view of the conversation environment to replace the list component with the contact component, the program instructions direct the computing system to render an animation of the list panel sliding out of and the contact panel sliding into the view of the conversation environment.

7. The one or more computer readable storage media of claim 6 wherein, to modify the view of the conversation environment to replace the contact component with the additional contact component, the program instructions direct the computing system to render an additional animation of the contact panel sliding out of and the additional contact panel sliding into the view of the conversation environment.

8. A computing apparatus comprising:
a computer readable storage media; and
program instructions stored on the computer readable storage media and executable by a processing system to facilitate a conversation environment, wherein the program instructions, when executed by the processing system, direct the processing system to at least:
initiate presentation of a view of the conversation environment comprising a conversation component within which to present communications exchanged during a conversation between a plurality of participants in the conversation and a contact component presented over a portion of the conversation component and comprising a plurality of additional contacts associated with one of a plurality of contacts corresponding to the plurality of participants in the conversation;
in response to an additional contact gesture corresponding to one of the plurality of additional contacts, initiate a modification to the view of the conversation environment to replace the contact component with an additional contact component associated with the one of the plurality of additional contacts.

9. The computing apparatus of claim 8 wherein, in response to a return gesture, the program instructions further direct the processing system to initiate another modification to the view of the conversation environment to replace either the contact component or the additional contact component with a list component comprising the plurality of contacts associated with the plurality of participants in the conversation.

10. The computing apparatus of claim 9 wherein the list component comprises a list panel, wherein the contact component comprises a contact panel, wherein the additional contact component comprises an additional contact panel, and wherein the view of the conversation environment comprises a single window view within which the list panel, contact panel, and additional contact panel are arranged.

11. The computing apparatus of claim 10 wherein the modification to the view of the conversation environment comprises an animated rendering of the additional contact panel replacing the contact panel and wherein the another modification to the view of the conversation environment comprises another animated rendering of the list panel replacing the contact panel.

12. The computing apparatus of claim 8 wherein the program instructions further direct the processing system to initiate another modification to the view of the conversation environment to include a settings component presented over another portion of the conversation component.

13. The computing apparatus of claim 8 further comprising the processing system configured to execute the program instructions and a display system configured to render and display the view of the conversation environment.

14. A method for facilitating a conversation environment comprising:
presenting a single window view of the conversation environment comprising a conversation component within which to present communications exchanged during a conversation between a plurality of participants in the conversation;
in response to a participant list gesture, modifying the view to include a list component presented over a portion of the conversation component and comprising a plurality of contacts associated with the plurality of participants; and,
in response to a contact gesture corresponding to one of the plurality of contacts, modifying the single window view to replace the list component with a contact component associated with the one of the plurality of contacts.

15. The method of claim 14 wherein the contact component comprises a plurality of additional contacts associated with the one of the plurality of contacts and wherein the method further comprises, in response to an additional contact gesture corresponding one of the plurality of additional contacts, modifying the single window view of the conversation environment to replace the contact component with an additional contact component.

16. The method of claim 15 wherein the method further comprises modifying the single window view of the conversation environment to replace the contact component with the list component in response to a return gesture.

17. The method of claim 16 further comprising modifying the single window view of the conversation environment to replace the additional contact component with the list component in response to an additional return gesture.

18. The method of claim 15 wherein the list component comprises a list panel, wherein the contact component comprises a contact panel, wherein the additional contact component comprises an additional contact panel.

19. The method of claim 18 wherein:
modifying the single window view of the conversation environment to replace the list component with the contact component comprises rendering an animation of the list panel sliding out of the single window view of the conversation environment and the contact panel sliding into the single window view of the conversation environment; and
modifying the single window view of the conversation environment to replace the contact component with the additional contact component comprises rendering an additional animation of the contact panel sliding out of the single window view of the conversation environment and the additional contact panel sliding into the view of the conversation environment.

20. The method of claim 18 further comprising, in response to a settings gesture, modifying the single window view of the conversation environment to include a settings panel presented over another portion of the conversation component.
